(19) United States
(12) Patent Application Publication
(10) Pub. No.: US 2006/0034579 A1
(43) Pub. Date: Feb. 16, 2006

(54) Surface emitting device and liquid crystal display device

(75) Inventor: Takuro Sugiura, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 11/201,350

(22) Filed: Aug. 10, 2005

(30) Foreign Application Priority Data
Aug. 11, 2004 (JP) 2004-234191

(51) Int. Cl. G02B 6/10

(52) U.S. Cl. 385/146

(57) ABSTRACT

A light source includes a rod-shaped optical waveguide body provided along a light-incident surface of the optical waveguide and light-emitting elements provided at least one end of the rod-shaped optical waveguide body in a width direction. A side surface of the rod-shaped optical waveguide body facing the light-incident surface of the optical waveguide serves as a light emission surface through which the light from the light-emitting elements is emitted to the optical waveguide, and another side surface thereof opposite to the light emission surface serves as a reflective surface for reflecting the light traveling within the rod-shaped optical waveguide body. In addition, a prism surface having a plurality of projections extending in the width direction of the rod-shaped optical waveguide body is formed on the light emission surface. A liquid crystal display device includes the surface emitting device.

This application claims the benefit of priority to Japanese Patent Application No. 2004-234191, filed on Aug. 11, 2004, herein incorporated by reference.

### BACKGROUND OF THE INVENTION

1. Field of the Invention

The present invention relates to a surface emitting device and a liquid crystal display device using the same.

2. Description of the Related Art

As a kind of surface emitting device, a front light of a reflective liquid crystal display device provided in portable electronic apparatuses, such as mobile phones, has been known.

FIG. 19 is a perspective view schematically showing the structure of a liquid crystal display device having a conventional surface emitting device as a front light.

The liquid crystal display device includes a liquid crystal display unit 120 and a surface emitting device 110 disposed at a front side (viewing side) of the liquid crystal panel 120 (for example, see Japanese Unexamined Patent Application Publication No. 10-19213).

Though not shown in the drawing, the liquid crystal display unit 120 includes a reflective liquid crystal display unit that displays an image by reflecting light incident from the front side. A liquid crystal layer is interposed between an upper substrate 121 and a lower substrate 122 opposite to each other. The liquid crystal display unit 120 performs display by controlling an alignment state of the liquid crystal layer to change the transmission state of light.

The surface emitting device 110 includes a plate-shaped optical waveguide 112, a rod-shaped optical waveguide body 113 disposed at a side surface (a light-incident surface) 112a of the optical waveguide 112, and light-emitting elements 115 disposed at both sides of the rod-shaped optical waveguide body 113 in a width direction. A plurality of projections 114, that is prisms, having wedge shapes in sectional view are provided parallel to each other on a top surface of the optical waveguide 112.

A light emission surface 113a (a surface facing the light-incident surface 112a of the optical waveguide 112) of the rod-shaped optical waveguide body 113 has a flat surface. A prism surface 113c is formed on an outer surface 113b opposite to the light emission surface 113a. The rod-shaped optical waveguide body 113 and the light-emitting elements 115 disposed at both sides thereof are integrally held by a metal case (not shown) formed outside the rod-shaped optical waveguide body 113 and the light-emitting elements 115.

In the surface emitting device 110, light emitted from the light-emitting elements 115 is introduced into the rod-shaped optical waveguide body 113 and travels therein. Then, the light is emitted from the light emission surface 113a to the light-incident surface 112a of the optical waveguide 112, such that the light is introduced into the optical waveguide 112. Subsequently, the light is reflected from the upper surface of the optical waveguide 112 having the prisms formed thereon, so that the traveling direction thereof is changed. Then, the light is emitted from a surface 112b (a bottom surface in the drawing) of the optical waveguide 112 opposite to a surface having convex portions 114 formed thereon toward the liquid crystal display unit 120.

In the conventional surface emitting device 110, however, the emission angle range of light L emitted from the light emission surface 113a of the rod-shaped optical waveguide body 113 is wide, as shown in FIG. 20. Therefore, there are problems in that light cannot be efficiently used, and brightness irregularity occurs in which only the vicinity of the light-incident surface 112a of the optical waveguide 112 is bright, but a central portion thereof is dark. Meanwhile, reference numeral 119 in FIG. 20 indicates a metal case.

If the brightness irregularity occurs in the optical waveguide 112, the uniformity in the amount of emission light within a light guide range becomes low. It is thus difficult to illuminate the liquid crystal display unit uniformly and brightly. This results in a low degree of visibility of display.

Furthermore, when viewed in a direction inclined about 10° from a normal direction of the surface emitting device 110, the conventional surface emitting device has a problem in that a dark portion 118 having a triangular shape in plan view occurs near the end surfaces in the width direction of the optical waveguide 112, as shown in FIG. 21. In the liquid crystal display device having the surface emitting device 110 having the above-mentioned structure, the brightness irregularity, such as the dark portion 118 that is visible to the eyes, occurs when viewed in the direction inclined about 10° from the normal direction.

The conventional surface emitting device 110 having the above-mentioned structure may be used as a backlight provided at the rear side of a transmissive or transflective liquid crystal display unit. In this case, for example, the optical waveguide 112 is disposed so that a surface (light incident from the optical waveguide is emitted from this surface) having the convex portions 114 formed thereon faces the liquid crystal display unit. A prism sheet (not shown) is disposed between the optical waveguide-112 and the liquid crystal display unit, and a reflective plate (not shown) is formed on the surface 112b opposite to the surface having the convex portions 114 formed thereon.

As such, even if the surface emitting device 110 is used as a backlight, there is a problem in that the brightness irregularity occurs within the optical waveguide or a dark portion occurs around the end surface of the optical waveguide, as in the case where the surface emitting device 110 is used as a front light.

Furthermore, there has been suggested another example of the conventional surface emitting device in which prism projections are disposed on a light emission surface of a rod-shaped optical waveguide body in a height direction (e.g., see Japanese Unexamined Patent Application Publication No. 2003-297126). In the surface emitting device, however, light emitted from the light emission surface of the rod-shaped optical waveguide body is diffused in a wide angle range. Accordingly, the utility efficiency of light emitted from the rod-shaped optical waveguide body is lowered.

Moreover, there has been proposed still another example of the conventional surface emitting device in which a prism sheet is interposed between a long cold-cathode tube and an incident surface of an optical waveguide (e.g., see Japanese Unexamined Patent Application Publication No. 9-166713). In the surface emitting device, however, since the prism sheet is separately provided from the light source, the brightness within the optical waveguide is lowered.

### SUMMARY OF THE INVENTION

Accordingly, the invention has been made in view of the above problems, and it is an object of the invention to provide a surface emitting device in which light emitted from an optical waveguide body can be incident on an optical waveguide with a high degree of efficiency, brightness within the optical waveguide can be improved, and brightness distribution of the optical waveguide can be controlled.

Another object of the invention is it to provide a liquid crystal display device having the above-mentioned surface emitting device having a high degree of visibility of display and high display quality.

In order to accomplish the above objects, the invention adopts the following construction.

According to an aspect of the invention, a surface emitting device includes a light source; and an optical waveguide that receives light emitted from the light source through one side surface thereof, and which emits the light traveling therein from one surface thereof. In the surface emitting device, the side surface of the optical waveguide on which the light is incident serves as a light-incident surface, and a plurality of prism grooves is formed in the other side surface of the optical waveguide in strip shapes in plan view. In addition, the light source includes a rod-shaped optical waveguide body disposed along the light-incident surface of the optical waveguide and light-emitting elements disposed at least one end of the rod-shaped optical waveguide body in a width direction. A side surface of the rod-shaped optical waveguide body facing the light-incident surface of the optical waveguide serves as a light emission surface through which the light from the light-emitting elements is emitted to the optical waveguide, and another side surface thereof opposite to the light emission surface serves as a reflective surface for reflecting the light traveling within the rod-shaped optical waveguide body. Further, a prism surface having a plurality of projections extending in the width direction of the rod-shaped optical waveguide body is formed on the light emission surface.

In the surface emitting device of the invention, the side surface of the rod-shaped optical waveguide body facing the incident surface of the optical waveguide serves as a light emission surface through which light is emitted from the light-emitting element to the optical waveguide. The prism surface having the plurality of projections extending in the width direction of the rod-shaped optical waveguide body is formed in the light emission surface. Accordingly, a large amount of light from the light emission surface of the rod-shaped optical waveguide body can be emitted around the normal direction (0°) of the incident surface of the optical waveguide. It is possible to prevent light from being emitted in an angle range greatly deviating from the normal direction (e.g., in an angle range where |θ| is larger than 20°, where θ is the emission direction of light emitted from the light emission surface of the rod-shaped optical waveguide body, and is an angle with respect to the normal direction of the light-incident surface). Further, since the emission direction of the light from the rod-shaped optical waveguide body has directivity, light emitted from the rod-shaped optical waveguide body can be incident on the optical waveguide with a high degree of efficiency.

Among light components emitted from the rod-shaped optical waveguide body, a light component emitted to the vicinity of the normal direction of the light-incident surface (which is referred to as near emission light. For example, |θ|≦20°) is introduced through the light-incident surface into the optical waveguide, and is guides up to a position far from the light-incident surface. Therefore, the amount of the near emission light is increased, and thus brightness at the center of the optical waveguide can be improved. Furthermore, among the light components emitted from the rod-shaped optical waveguide body, the number of light components emitted in an angle range that is far from the normal direction of the light-incident surface (which is referred to as far emission light) is reduced. Therefore, according to the present invention, brightness within the optical waveguide can be improved, and the brightness distribution of the optical waveguide can be controlled. It is thus possible to increase the amount of emission light within the optical waveguide, and also to control the distribution of the amount of emission light within the optical waveguide.

In the surface emitting device of the present invention, light emitted from the rod-shaped optical waveguide body can be efficiently incident on the optical waveguide, and thus a large amount of light travels to the end surface of the optical waveguide in the width direction. Thus, when viewed in a direction inclined about 10° from the normal direction of the surface emitting device, a dark portion having a triangular shape in plan view can be prevented from occurring around the end surface of the optical waveguide in the width direction.

Furthermore, the surface emitting device of the present invention can be properly used as a front light or backlight provided in the liquid crystal display device. When the surface emitting device is used as a backlight, the brightness at the center of the optical waveguide has a great influence on the visibility of display. However, since the center of the optical waveguide can be made bright in plan view, the visibility of display can be improved when the surface emitting device is provided in the liquid crystal display device as a backlight.

By changing the apex angle of the projection, it is possible to change the distribution of the emission angle of light emitted from the light emission surface of the rod-shaped optical waveguide body.

In the surface emitting device having the above-mentioned structure according to the invention, it is preferable that the apex angle of the projections formed in the light emission surface of the rod-shaped optical waveguide body be in the range of 45 to 130°, which makes it possible to improve the brightness within the optical waveguide surface, more particularly, to improve the brightness at the center of the optical waveguide in plan view.

In the above-mentioned structure, it is preferable that a pitch between the projections formed in the light emission surface of the rod-shaped optical waveguide body be smaller than a third of the thickness of the rod-shaped optical waveguide body. In this case, it is possible to improve the efficiency of light emitted from the rod-shaped optical waveguide body to be incident on the optical waveguide.

According to another aspect of the invention a liquid crystal display device includes a liquid crystal display panel; and the above-mentioned surface emitting device that is provided on a viewing side of the liquid crystal display panel such that one surface of an optical waveguide faces the liquid crystal display panel.

In the liquid crystal display device, the surface emitting device having the above-mentioned structure according to the present invention is provided on the viewing side of the liquid crystal display panel as a front light. Therefore, when the surface emitting device of the present invention is turned on, the liquid crystal display panel can be illuminated uniformly and brightly, which makes it possible to improve the visibility of display and to obtain high display quality.

Furthermore, in the above-mentioned structure, it is preferable that the prism sheet be provided on one surface of the optical waveguide, and that a reflective plate be provided on the other surface of the optical waveguide.

The surface emitting device having the above-mentioned structure can be suitably used as a backlight of the liquid crystal display panel. Thus, it is possible to make light emitted from the optical waveguide body incident on the optical waveguide with a high degree of efficiency, and thus to improve brightness within the optical waveguide. In addition, it is possible to control the brightness distribution of the optical waveguide.

Furthermore, according to still another aspect of the invention, a liquid crystal display device includes a liquid crystal display panel; and the above-mentioned surface emitting device that is provided on a rear side of the liquid crystal display panel such that one surface of an optical waveguide faces the liquid crystal display panel.

According to the liquid crystal display device, the surface emitting device having the above-mentioned structure according to the present invention is provided on the rear side of the liquid crystal display panel as a backlight. Therefore, when the surface emitting device of the present invention is turned on, the liquid crystal display panel can be illuminated uniformly and brightly, which makes it possible to improve the visibility of display and to obtain high display quality.

### BRIEF DESCRIPTION OF THE DRAWINGS

FIG. 1 is a schematic perspective view illustrating the structure of a liquid crystal display device according to an embodiment in which a surface emitting device according to the present invention is provided as a front light;

FIG. 2 is a longitudinal cross-sectional view of the liquid crystal display device shown in FIG. 1;

FIG. 3 is a perspective view of a rod-shaped optical waveguide body and a light-emitting element that constitute a light source of the surface emitting device provided in the liquid crystal display device shown in FIG. 1;

FIG. 4 is a cross-sectional view of the rod-shaped optical waveguide body taken along the line IV-IV of FIG. 3;

FIG. 5 is a perspective view of the rod-shaped optical waveguide body shown in FIG. 3, as viewed from a reflective surface side;

FIG. 6 is a schematic perspective view illustrating the structure of a liquid crystal display device according to an embodiment in which a surface emitting device according to the present invention is provided as a backlight;

FIG. 7 is a view showing the apex angle and distribution of the emission angle of projections of a light emission surface of a rod-shaped optical waveguide body;

FIG. 8 is a view showing brightness distribution of an optical waveguide of a backlight according to an embodiment in which the apex angle of the projections of a light emission surface of the rod-shaped optical waveguide body is 120°;

FIG. 9 is a view showing brightness distribution of the optical waveguide of the backlight according to an embodiment in which the apex angle of the projections on the light emission surface of the rod-shaped optical waveguide body is 90°;

FIG. 10 is a view showing brightness distribution of the optical waveguide of the backlight according to an embodiment in which the apex angle of the projection of the light emission surface of the rod-shaped optical waveguide body is 60°;

FIG. 11 is a view showing brightness distribution of the optical waveguide of the backlight according to a comparative example in which the light emission surface of the rod-shaped optical waveguide body is flat;

FIG. 12 is a graph showing the relation between an apex angle of the projections of the light emission surface of the rod-shaped optical waveguide body, an average value of brightness of twenty five regions of the optical waveguide of the backlight, and an average value of brightness of nine regions around the center thereof;

FIG. 13 is a graph showing the relation between the apex angle of the projection of the light emission surface of the rod-shaped optical waveguide body and the brightness of each of positions in a light-incident surface of the optical waveguide of the backlight;

FIG. 14 is a graph showing brightness distribution of in the vertical direction within the optical waveguide in the backlights according to an example and a comparative example;

FIG. 15 is a graph showing brightness distribution in the horizontal direction within the optical waveguide in the backlights according to an example and a comparative example;

FIG. 16 is a graph showing average brightness in the case of white display of the front lights according to an example and a comparative example;

FIG. 17 is a graph showing average contrast of the front light according to an example and a comparative example;

FIG. 18 is a graph showing the brightness ratio of the liquid crystal display device according to an example and a comparative example to the backlight according to an example and a comparative example;

FIG. 19 is a schematic perspective view illustrating the structure of a liquid crystal display device having a conventional surface emitting device;

FIG. 20 is a cross-sectional view taken along a normal line of the liquid crystal display device shown in FIG. 19; and

FIG. 21 is a plan view of the surface emitting device provided in the liquid crystal display device of FIG. 19 as viewed from a viewing side.

### DESCRIPTION OF THE PREFERRED EMBODIMENT

Preferred embodiments of the invention will now be described with reference to the accompanying drawings.

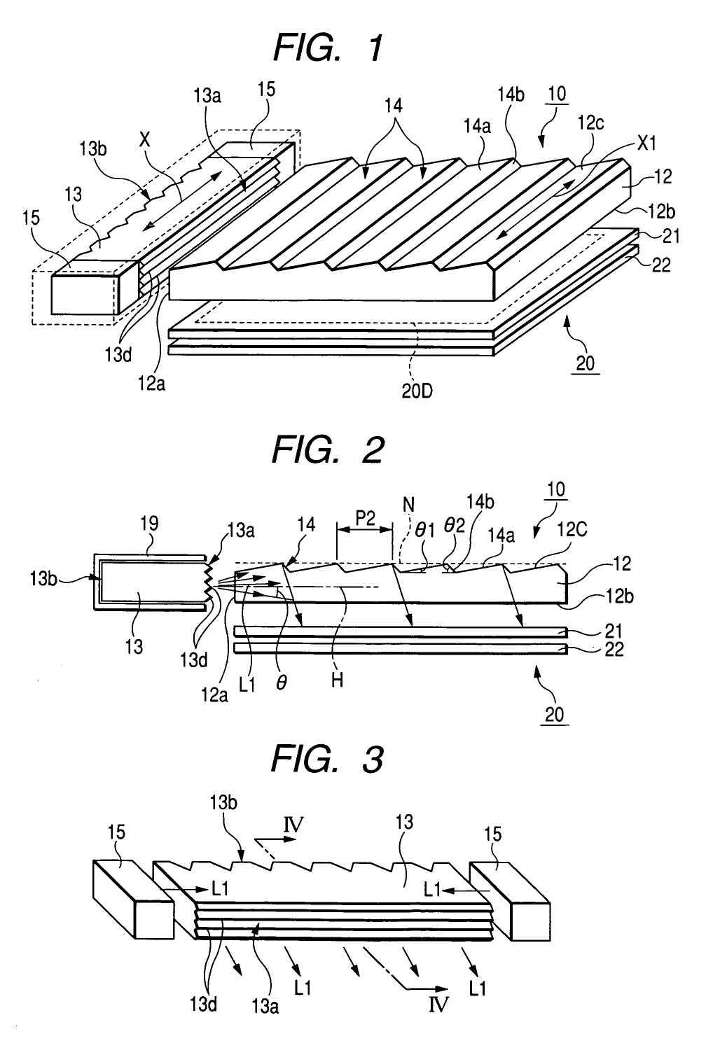

FIG. 1 is a perspective view schematically illustrating the structure of a liquid crystal display device according to an embodiment of the invention in which a surface emitting device is provided as a front light. FIG. 2 is a longitudinal cross-sectional view of the liquid crystal display device shown in FIG. 1.

The liquid crystal display device according to the present embodiment includes a reflective liquid crystal display unit (a liquid crystal display panel) 20 and a front light (a surface emitting device) 10 disposed on a viewer side (an upper side of the drawings) of the liquid crystal display unit, as shown in FIGS. 1 and 2.

The front light 10 includes a transparent optical waveguide 12 having a substantial plate shape, a bar optical waveguide body (a rod-shaped optical waveguide body) 13 disposed along a lateral cross section 12a of the transparent optical waveguide 12, light-emitting elements 15 disposed at both sides of the rod-shaped optical waveguide body 13 in the width direction (which is referred to as the lengthwise direction of the rod-shaped optical waveguide body), and a case 19 deposited on the rod-shaped optical waveguide body 13 to cover the rod-shaped optical waveguide body 13 and the light-emitting elements 15, as shown in FIG. 1. That is, in the front light 10 according to the present embodiment, a light source includes the rod-shaped optical waveguide body 13 and the light-emitting elements disposed at both sides of the rod-shaped optical waveguide body 13, and the lateral cross section 12a of the optical waveguide 12 becomes an incident surface. FIG. 3 is a perspective view of the light source provided in the front light 10.

The optical waveguide 12 is disposed on a display region 20D of the liquid crystal display unit 20. The optical waveguide 12 is a plate-shaped member which changes the traveling direction of light incident from the rod-shaped optical waveguide body 13 within the optical waveguide 12 and emits the light to the liquid crystal display unit 20. The optical waveguide 12 is made of, for example, a transparent acrylic resin.

The size of the optical waveguide 12 is greater than that of the display region 20D of the liquid crystal display unit 20 in plan view. A region on the surface of the optical waveguide 12 corresponding to the display region 20D of the liquid crystal display unit 20 serves as a display region. The front light 10 is used to perform transmissive display on the display region 20D of the liquid crystal display unit 20 (an object to be illuminated).

Furthermore, a top surface (the other surface) of the optical waveguide 12 serves as a reflective surface 12c in which prism grooves 14 having a wedge shape are formed parallel to each other in sectional view and are formed in a stripe shape in plan view. A bottom surface (one surface) of the optical waveguide 12 serves as a light emission surface 12b from which illumination light for illuminating the liquid crystal display unit 20 is emitted. The prism grooves 14 having the wedge shape in sectional view are formed on the entire top surface 12c of the optical waveguide 12.

Each of the prism grooves 14 includes a pair of slant surface portions that are inclined with respect to a reference surface N of the reflective surface 12c. One of the slant surface portions serves as a gentle slant portion 14a, and the other of the slant surface portions serves as a sharp slant portion 14b having a tilt angle higher than that of the gentle slant portion 14a.

The optical waveguide 12 reflects light traveling in the optical waveguide (light traveling from the left side to the right side in FIG. 2) to the light emission surface 12b by means of the sharp slant portions 14b of the reflective surface 12c. Then, the reflected light is emitted to the liquid crystal display unit 20 disposed on the light emission surface of the optical waveguide 12.

The optical waveguide 12 can be made of, for example, a transparent resin material, such as acrylic-based resin, polycarbonate-based resin, or epoxy resin, or glass. Further, specifically, the optical waveguide 12 can made of, for example, Arton (a trade mark: which is available from JSR Co., Ltd.), Zeonor (a trade mark: which is available from Xeon Corporation, Japan), but the material is not limited thereto.

Furthermore, in the optical waveguide 12, the amount of emission light can become uniform from the entire surface of the optical waveguide as the thickness of the optical waveguide is larger. Thus, the optical waveguide 12 preferably has a thickness larger than 0.5 mm, and more preferably a thickness of 0.5 to 1.5 mm.

The rod-shaped optical waveguide body 13 is a transparent member having a square pillar shape corresponding to the light-incident surface 12a of the optical waveguide 12. The light-emitting elements 15 are disposed at both sides of the rod-shaped optical waveguide body 13 in the width direction thereof.

The rod-shaped optical waveguide body 13 can be made of, for example, a transparent resin material, such as acrylic-based resin, polycarbonate-based resin, and or resin, or glass.

A side surface of the rod-shaped optical waveguide body 13 facing the light-incident surface of the optical waveguide 12 serves as the light emission surface 13a through which light from the light-emitting elements 15 is emitted to the optical waveguide 12. A side surface of the optical waveguide body 13 opposite to the light emission surface 13a serves as the reflective surface 13b for reflecting light traveling within the rod-shaped optical waveguide body 13.

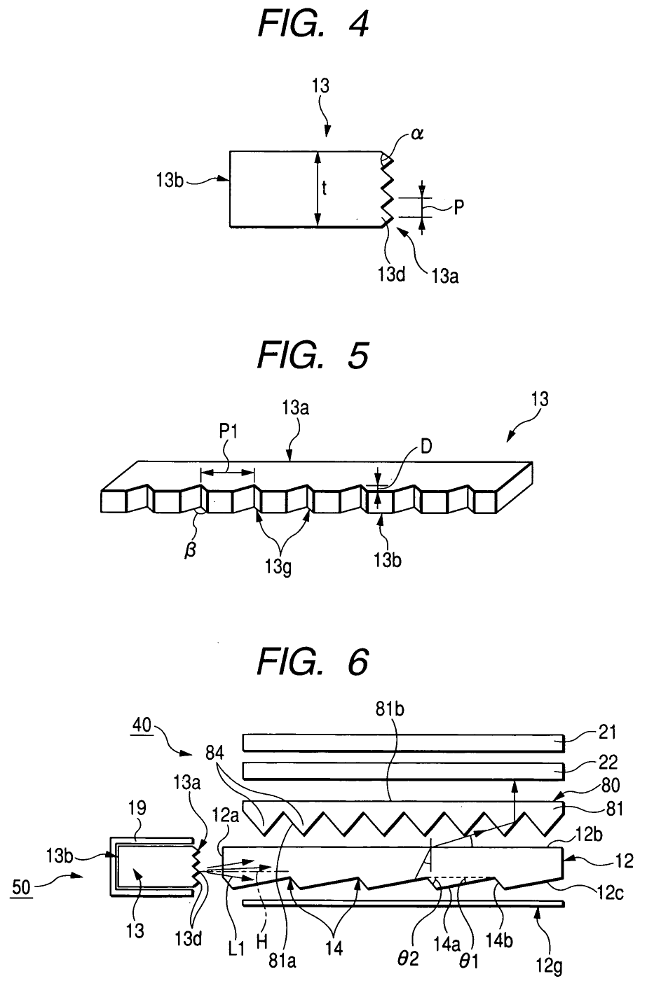

As shown in FIGS. 1 to 3, the light emission surface 13a of the rod-shaped optical waveguide body 13 becomes a prism surface in which a plurality of projections 13d is formed in a width direction (longitudinal direction) X of the rod-shaped optical waveguide body 13. Each of the projections 13d is a long projection having a pair of slant surfaces. Each of the projections 13d has a triangular shape in longitudinal cross-sectional view, as shown in FIG. 4.

As shown in FIG. 4, when an apex angle α of each of the projections 13d is in a range of 45° to 130°, brightness within the surface of the optical waveguide can be improved. In particular, this is preferable since brightness at the central portion of the optical waveguide 12 in plan view can be improved. Further, it is preferable that a pitch P between the projections 13d (between apexes of adjacent projections 13d) is smaller than a third of a thickness (height) t of the rod-shaped optical waveguide body 13 in order to improve the efficiency of light emitted from the rod-shaped optical waveguide body 13 to the optical waveguide 12.

Furthermore, as shown in FIG. 5, the surface (the reflective surface) 13b of the rod-shaped optical waveguide body 13 opposite to the light emission surface 13a becomes a prism surface in which a plurality of grooves 13g having a wedge shape in plan view are formed parallel to each other. Light emitted from the light-emitting elements 15 travels in the inside of the rod-shaped optical waveguide body 13 in the longitudinal direction of the rod-shaped optical waveguide body 13. It is then reflected from inner surfaces of the wedge-shaped grooves to be emitted from the light emission surface 13a to the optical waveguide 12. Each of the wedge-shaped grooves 13g is formed in the thickness direction (the height direction) of the rod-shaped optical waveguide body.

The wedge-shaped grooves 13g preferably have a depth D, which becomes larger as they become more distant from the light-emitting elements 15. That is, the wedge-shaped groove 13g located at the central portion of the reflective surface 13b in the longitudinal direction has the largest depth. The depth of the wedge-shaped groove 13g becomes smaller as closer to the end portions of the prism surface. It is therefore possible to improve the uniformity of light incident on the side surface 12a of the optical waveguide 12.

Further, a pitch P1 between the wedge-shaped grooves 13g (a distance between the apexes of adjacent wedge-shaped grooves) becomes smaller as the wedge-shaped grooves 13g become more distant from the light-emitting elements 15. It is thus possible to improve the uniformity of light incident on the side surface 12a of the optical waveguide 12.

Further, it is preferable that an apex angle β of the wedge-shaped groove 13g be an obtuse angle to improve brightness of light incident on the side surface 12a of the optical waveguide 12.

Furthermore, the prism surface of the rod-shaped optical waveguide body in which the plurality of wedge-shaped grooves 13g are formed has a thin reflective film (not shown) made of a metallic material having high reflectance, such as Al or Ag, which makes it possible to improve the reflectance of the prism surface. Thus, the amount of light incident on the optical waveguide 12 can be increased.

Further, as the light-emitting element 15, for example, a white LED (light-emitting diode) or an organic EL element can be used.

At least the inner surface of the case 19 preferably has reflexibility. A metal reflective film can be formed on the inner surface, or the entire case can be made of a metallic material having reflexibility, such as Al or Ag. The light emission surface 13a of the rod-shaped optical waveguide body 13 is an exposed surface that is not covered with the case 19.

The liquid crystal display unit 20 is a reflective liquid crystal display unit capable of performing color display. The reflective liquid crystal display unit has a structure in which a liquid crystal layer (not shown) is interposed between an upper substrate 21 and a lower substrate 22 that are opposite to each other, a plurality of transparent electrodes (not shown) having strip shapes in plan view and an alignment film (not shown) formed on these transparent electrodes are provided on the inner surface of the upper substrate 21, and a reflective layer (not shown), a color filter layer (not shown), a plurality of transparent electrodes (not shown) having strip shapes in plan view, and an alignment film (not shown) are sequentially formed on the inner surface of the lower substrate 22.

In the liquid crystal display unit 20, the rectangular region 20D represented by a one-dot chain line in FIG. 1 serves as a display region of the liquid crystal display unit 20, and pixels (not shown) are formed in a matrix in the display region D.

In the liquid crystal display device of the present embodiment, the front light 10 having the above-mentioned structure is arranged on the liquid crystal display unit 20 with the light emission surface 12b thereof facing the viewer side (on the side of the upper substrate 21) of the liquid crystal display unit 20, so that display of the liquid crystal display unit 20 can be seen to the eyes through the optical waveguide 12 constituting the front light 10.

In the liquid crystal display device, the light-emitting elements 15 are turned on in dark places where external light cannot be obtained to introduce light L1 respectively emitted from the light-emitting element 15 and 15 into the rod-shaped optical waveguide body 13, and then the light L1 travels inside the rod-shaped optical waveguide body 13 to be emitted from the light emission surface 13a to the optical waveguide through the incident surface 12a. Then, the light L1 is emitted from the light emission surface 12b of the optical waveguide 12 to the liquid crystal display unit 20 to illuminate the liquid crystal display unit 20.

In the front light 10 of the present embodiment, the prism surface having the plurality of projections 13d in the width direction X of the rod-shaped optical waveguide body 13 is formed on the light emission surface 13a of the rod-shaped optical waveguide body 13. It is thus possible to condense the emission direction of the light L1 emitted from the light emission surface 13a of the rod-shaped optical waveguide body 13 onto the vicinity of a normal direction H (0°) of the incident surface 12a of the optical waveguide 12, as shown in FIG. 2. It is also possible to reduce the amount of light emitted in an angle range that is far from the normal direction H (for example, |θ|>20° (where θ is an angle with respect to the normal direction H of the incident surface 12a in the emission direction of the light L1 emitted from the light emission surface 13a of the rod-shaped optical waveguide body 13). The emission direction of the light emitted from the rod-shaped optical waveguide body 13 has directivity. Accordingly, the light emitted from the rod-shaped optical waveguide body 13 can be incident on the optical waveguide 12 with a high degree of efficiency. FIG. 2 schematically illustrates a difference in the amount of the light L1 in the emission direction, and the lengths of arrows are proportional to the amounts of light in FIG. 2.

Among the light L1 emitted from the rod-shaped optical waveguide body 13, a light component of emitted to the vicinity of the normal direction H of the light-incident surface 12a (near emission light, e.g., |θ|≦20°) is introduced to the optical waveguide through the light-incident surface 12a, and is guided up to a position that is far from the light-incident surface 12a. Thus, brightness at the central portion of the optical waveguide 12 in plan view can be improved since the amount of the near emission light increases. Further, among the light components emitted from the rod-shaped optical waveguide body 13a, a light component (far emission light, e.g., |θ|>20°) emitted in an angle range that is far from the normal direction H of the light-incident surface 12a is difficult to be guided into the optical waveguide even if it is incident on the optical waveguide. Accordingly, light is easily emitted from the vicinity of the rod-shaped optical waveguide body, but the amount of the far emission light is reduced.

Accordingly, in accordance with the front light 10 of the present embodiment, brightness within the surface of the optical waveguide can be improved, and the brightness distribution of the optical waveguide 12 can be controlled. It is thus possible to increase the amount of light emitted the surface of the optical waveguide, and also to control the distribution of the amount of light emitted the surface of the optical waveguide.

In the front light of the present embodiment, the light L1 emitted from the rod-shaped optical waveguide body 13 is efficiently incident on the optical waveguide, so that a large amount of light L1 travels around the cross section of the optical waveguide 12 in the width direction. Therefore, it is possible to solve the problem of a dark portion having a triangular shape in plan view being viewed around end portions of the optical waveguide 12 in the width direction X1 when viewed in a direction which is inclined with respect to the normal direction of the surface of the front light by 10°.

As such, in the liquid crystal display device of the present embodiment in which the light L1 emitted from the rod-shaped optical waveguide body 13 can be efficiently incident on the optical waveguide 12 and the front light 10 having improved brightness within the surface of the optical waveguide is provided, when the front light 10 is turned on, the display region 20D of the liquid crystal display unit 20 can be uniformly and brightly illuminated by the front light 20. Further, a dark portion does not occur around the end portions of the optical waveguide in the width direction even if it is viewed in the direction inclined about 10° from the normal direction of the liquid crystal display device. Accordingly, the visibility of display can be improved, and high-quality display can be obtained.

Furthermore, in the surface emitting device of this embodiment, the light-emitting elements are respectively disposed at both ends of the rod-shaped optical waveguide body 13 in the width direction thereof. However, the light-emitting element 15 may be disposed at least one end of the rod-shaped optical waveguide body 13 in the width direction thereof.

It has also been described that the longitudinal cross section of the projections formed in the light emission surface 13a of the rod-shaped optical waveguide body 13 has a triangular shape. However, the projections may be formed in hemispherical shapes.

Furthermore, in the above-described embodiment, the liquid crystal display unit 20 having the surface emitting device 10 is a reflective type. However, the liquid crystal display unit 20 may be a transmissive or transflective liquid crystal display unit (a liquid crystal display panel). The surface emitting device according to the invention is provided at the rear surface side of the transmissive or transflective liquid crystal display unit as a backlight, and the other surface (a surface having the prism grooves formed therein) of the optical waveguide of the surface emitting device faces the liquid crystal display unit.

FIG. 6 is a perspective view schematically illustrating the structure of a liquid crystal display device according to an embodiment of the invention in which the surface emitting device is provided as a backlight.

The liquid crystal display device shown in FIG. 6 includes a transmissive or transflective liquid crystal display unit (a liquid crystal display panel) 40 and a backlight (a surface emitting device) 50 disposed at the rear surface (a lower side in the drawing) of the liquid crystal display unit 40. One or more retardation plates (not shown) and polarizing plates (not shown) are disposed between the liquid crystal display unit 40 and the backlight 50.

In the case where the liquid crystal display unit 40 is of a transflective type, it is different from the reflective liquid crystal display unit 20 in that a plurality of through holes through which light from the backlight is transmitted is formed in a reflective layer, and in that a lower substrate 22 is made of a transparent material. On the other hand, in the case where the liquid crystal display unit 40 is of a transmissive type, the lower substrate 22 is made of a transparent material, and the liquid crystal display unit is not provided with the reflective layer.

The backlight 50 is different from the surface emitting device 10 shown in FIGS. 1 and 2 in that a prism sheet 80 is disposed on a light emission surface (one surface 12b) of the optical waveguide 12, and in that a thin reflective plate 12g made of, for example, Ag is disposed below a surface 12c opposite to the light emission surface 12b. The backlight 50 is disposed such that the light emission surface of the optical waveguide 12 faces the liquid crystal display panel 40.

Prism grooves 14 having wedge shapes in sectional view are formed on a surface (the other surface 12c) of the optical waveguide 12 in a strip shape in plan view, similar to the surface emitting device 10. Further, a rod-shaped optical waveguide body 13 is disposed along the light-incident surface 12a of the optical waveguide 12 in the same manner as the surface emitting device 10. Light-emitting elements 15 are disposed at both sides of the rod-shaped optical waveguide body 13, respectively.

A plurality of projections 13d is formed on the light emission surface 13a of the rod-shaped optical waveguide body 13 along the width direction (a longitudinal direction) of the rod-shaped optical waveguide body 13 in the same manner as the surface emitting device 10.

In the prism sheet 80, a plurality of refractive projecting portions 84 each having a refractive surface and a reflective surface is consecutively formed on an incident surface 81a (a surface facing the optical waveguide) of a transparent sheet 81. A light emission surface 81b opposite to the incident surface 81a is a flat surface. The transparent sheet 81 constituting the prism sheet 80 can be made of, for example, a transparent resin material, such as acrylic based resin, polycarbonate based resin, or epoxy resin, or glass.

The refractive portions 84 cause light incident in a direction inclined from the transparent sheet 81 to be incident on the transparent sheet 81 by means of the refractive surface, and cause the incident light to be reflected from the transparent sheet 81 by means of the reflective surface and then to be emitted from the light emission surface 81b to the liquid crystal panel 40.

The prism sheet 80 is interposed between the optical waveguide 12 and the liquid crystal display unit 40 (more particularly, between the polarizing plate and the optical waveguide 12 under the liquid crystal display unit). The incident surface 81a of the prism sheet 80 on which the plurality of refractive portions 84 is provided is disposed to face the light emission surface 12b of the optical waveguide 12.

A number of minute concave and convex portions are randomly formed on a top surface (a surface facing the optical waveguide 12) of the reflective plate 12g.

In the liquid crystal display device of FIG. 6, the backlight 50 having the above-mentioned structure is disposed on the rear side of the liquid crystal display panel 40. Thus, when the backlight 50 is turned on, the liquid crystal display panel 40 can be uniformly and brightly illuminated by the backlight 50. The visibility of display can be improved, and high-quality display can be obtained.

### EXAMPLES

Hereinafter, the invention will be described in more detail in connection with examples. It is, however, to be understood that the following examples are not intended to limit the invention.

### Experimental Example 1

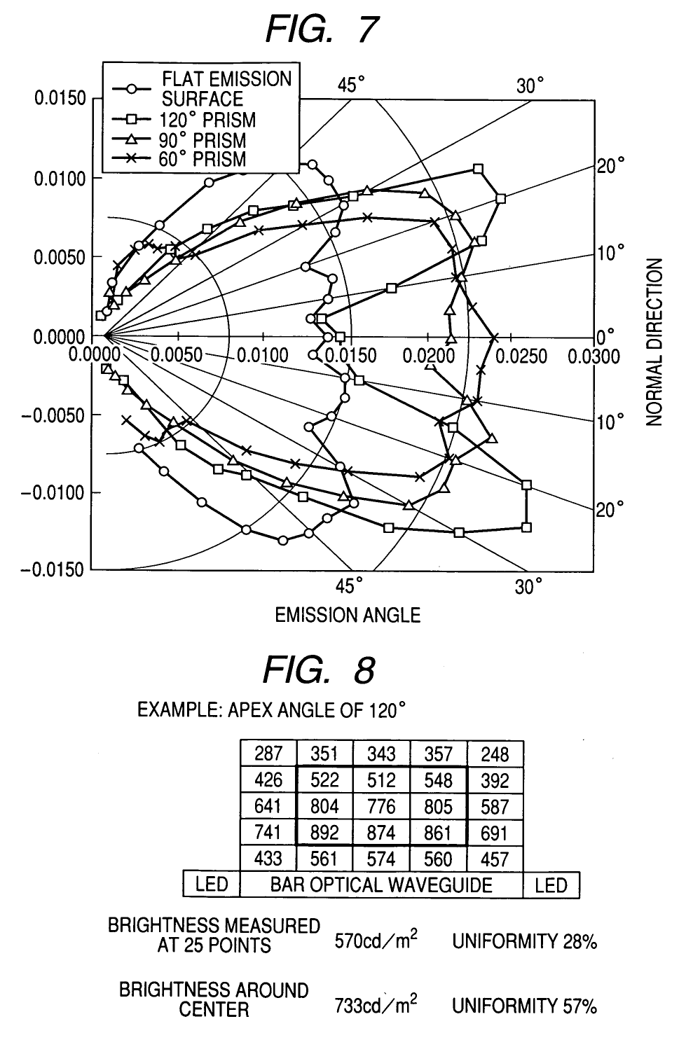

In the present experimental example, light emitted from the light emission surface 13a when the light-emitting elements 15 are turned on is received by a light-receiving unit BM-5A, and distribution of an emission angle of the light is measured, in a state where the apex angle of the projection 13d of the prism surface formed on the light emission surface 13a of the rod-shaped optical waveguide body 13 is set in the range of 45° to 120°, and the light source according to the embodiment shown in FIG. 1 or 6 (the rod-shaped optical waveguide body 13, the light-emitting elements 15 disposed at both sides of the rod-shaped optical waveguide body 13, and the case 19, made of Al, enclosing these components) is fabricated. The measured results are shown in FIG. 7.

For the purpose of comparison, the distribution of emission angles is also measured from the light source (a comparative example) having the same structure as that in the above-mentioned embodiment except that the light emission surface 13a of the rod-shaped optical waveguide body 13 is flat. The measured results are shown in FIG. 7. Furthermore, the graph of FIG. 7 shows distribution of brightness when a distribution area is normalized to 1.

In this case, the rod-shaped optical waveguide body 13 is made of an acrylic resin in a rod shape in which the length thereof in the width direction X is 68.8 mm, a distance between the surface 13b and the surface 13a not having the grooves 13g or the projections 13d is 2.5 mm, a thickness thereof is 0.90 mm, a pitch P between the projections 13d in the light emission surface 13g is 24 μm, and V-shaped grooves 13g having an apex angle β of 102° are formed in the surface 13b so that the pitch therebetween becomes gradually narrow in the range of 0.25 mm (both ends) to 0.211 mm (a central portion). Furthermore, these grooves 13g are formed such that depths thereof become gradually large in range of 7.6 μm (both ends) to 73.5 μm (the central portion). LEDs (NSCW215T (a trade mark; which is available from Nichia Corporation) are used as the light-emitting elements disposed at both ends of the rod-shaped optical waveguide body.

From the results shown in FIG. 7, it can be seen that, in the light source of the comparative example in which the light emission surface of the rod-shaped optical waveguide body is flat, light emitted from the light emission surface has a wide emission angle, and more particularly, the light is emitted in the range of about 0° to 45°. To the contrary, it can be seen that, in the light source of the example in which the prism surface having the plurality of projections in the width direction is formed on the light emission surface of the rod-shaped optical waveguide body, light emitted from the light emission surface has a narrow emission angle, compared to the comparative example, and a large amount of light is emitted in the range close to the normal direction. When the apex angle ‘α’ of the projections is in the range of 60° to 120°, a large amount of light is emitted in the range of about 0° to 30°. More particularly, when the apex angle ‘α’ is 90° and 60°, a large amount of light is emitted in an angle range close to the normal direction, compared to the case where the apex angle ‘α’ is 120°. When the apex angle ‘α’ is 60°, a large amount of light is emitted in the range of about 0° to 20°. Accordingly, by narrow the apex angle of the projections formed in the light emission surface of the rod-shaped optical waveguide body, the emission angle range can be made narrow, and a large amount of light can be emitted in the angle range close to the normal direction.

### Experimental Example 2

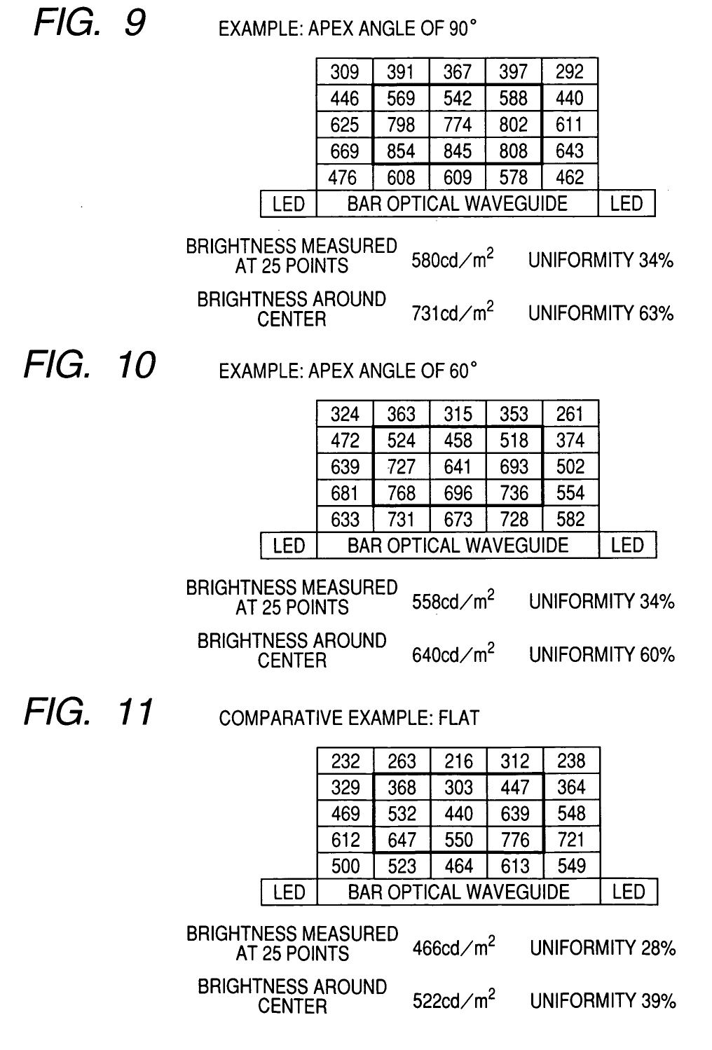

Brightness inside the optical waveguide is measured using Risa-Color (manufactured by HI-LAND CO., LTD.) when the backlight (example) shown in FIG. 6 is manufactured by a combination of light source, the optical waveguide 12, the prism sheet 80, and the reflective plate 12g which are fabricated in the experimental example 1. The measured results are shown in FIGS. 8 to 10. In this case, when measuring the distribution of brightness, the inner surface of the optical waveguide is divided into twenty-five regions in plan view, and the brightness of a central point of each region is measured.

For the purpose of comparison, brightness inside the optical waveguide is measured in the same method as described above, when the backlight (comparative example) is manufactured by a combination of the light source and the optical waveguide 12 of the comparative example, which are fabricated in the experimental example 1. The measured results are shown in FIG. 11.

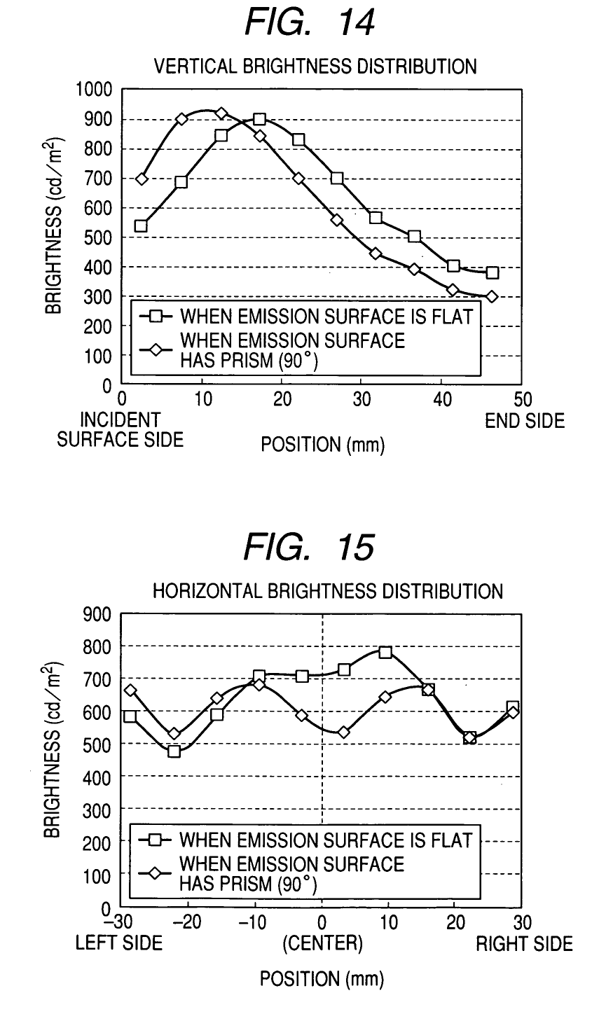

Furthermore, for the backlight according to the present example using the rod-shaped optical waveguide body in which the apex angle of the projection on the emission surface is 90° and the backlight according to the comparative example using the rod-shaped optical waveguide body in which the emission surface is flat, the distribution of brightness in the vertical direction inside the optical waveguide and the distribution of brightness in the horizontal direction inside the optical waveguide are measured, respectively, and measured results are shown in FIGS. 14 and 15.

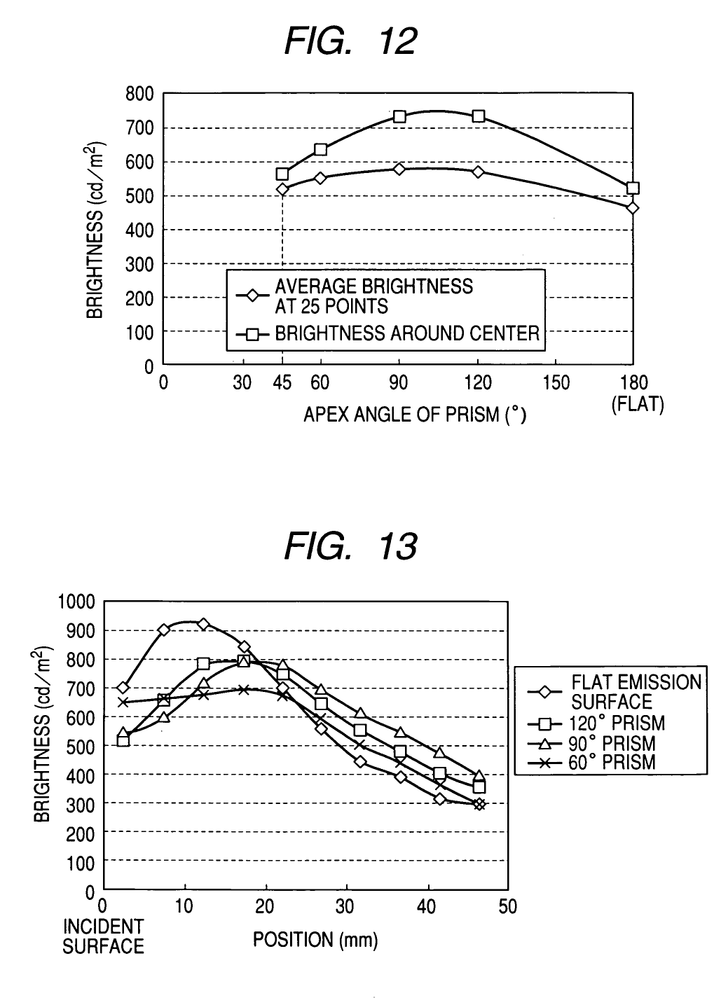

Furthermore, the apex angle of the projection of the light emission surface of the rod-shaped optical waveguide body, the average value of the brightness of twenty five regions of the optical waveguide of the fabricated backlight, and the average value of the brightness of nine regions of the twenty five regions around the center of the optical waveguide in plan view are calculated. The calculation results are shown in FIG. 12.

Further, the apex angle of the projection of the light emission surface of the rod-shaped optical waveguide body and the brightness of each position (distance) apart from the light-incident surface of the optical waveguide of the fabricated backlight are measured, and the measured results are shown in FIG. 13.

In this case, the optical waveguide 12 has a size of 66.8 mm×54.1 mm×0.8 mm, and has the same construction as that shown in FIG. 6 in which the plurality of prism grooves 14 is formed on the reflective surface 12c. An acrylic resin is used as a forming material. At this time, a pitch P2 between the prism grooves 14 is set to 0.3 mm. Further, in two slant portions constituting each of the prism grooves, a tilt angle θ2 of the sharp slant portion 14b is set to 50°, and a tilt angle 01 of the gentle slant portion 14a is set to 2.0°.

The prism sheet 80 is laminated on the light emission surface 12b of the optical waveguide 12. The reflective plate 12g made of, for example, Al is formed on the surface 12c opposite to the light emission surface 12b. An acrylic resin is used for forming the transparent sheet constituting the prism sheet 80. The light source fabricated in the experimental example 1 is disposed on the light-incident surface 12a of the optical waveguide 12.

From the results shown in FIGS. 8 to 13, in the backlight of the comparative example employing the rod-shaped optical waveguide body in which the light emission surface is flat (the apex angle of the prism is 180°), the average value of brightness of the twenty five regions of the optical waveguide is 466 cd/m², and the brightness uniformity is 28%. In addition, the average value of the brightness of the nine regions around the center is 522 cd/m², and the brightness uniformity is 39%. In this case, the brightness uniformity can be represented by the ratio of the lowest brightness within each region to the highest brightness. The larger the value is, the smaller a variation in brightness becomes. It can be seen that the backlight of the comparative example has peak brightness about 10 mm apart from the light-incident surface of the optical waveguide. It can also be seen that the reduction ratio of brightness is high and the brightness around the center of the optical waveguide is low if the distance between the backlight and the incident surface is larger than about 20 mm.

On the other hand, in the backlight according to the present example using the rod-shaped optical waveguide body of the prism surface (the apex angle of the prism is in the range of 45° to 120°) in which the plurality of projections is formed in the light emission surface, the average value of brightness of the twenty five regions of the light guide and the uniformity of brightness are higher than those in the comparative example. Further, the average value of the brightness of the nine regions around the center is higher than that in the comparative example. Thus, if the projections extending in the width direction are formed on the light emission surface of the rod-shaped optical waveguide body, brightness within the optical waveguide can be improved, and the uniformity of brightness distribution can be improved.

Furthermore, the peak of brightness of the backlight of the present example shifts around the center of the optical waveguide. More particularly, when the apex angle is in the range of 90° to 120°, the brightness is higher than the comparative example at a position of larger than 20 mm apart from the light-incident surface. When the apex angle is 60°, the brightness is higher than the comparative example at a position of larger than 25 mm apart from the light-incident surface.

Furthermore, from the results shown in FIG. 14, it can be seen that, in the backlight (the apex angle of the projection is 90°) of the present example, brightness distribution in the vertical direction inside the optical waveguide shifts to the central direction of the optical waveguide, compared to the backlight of the comparative example. From the results shown in FIG. 15, it can be seen that, in the backlight (the apex angle of the projection is 90°) of the embodiment, brightness distribution in the horizontal direction inside the optical waveguide is improved around the center of the optical waveguide, compared to the backlight of the comparative example.

From the above experimental results, it can be seen that, by using the rod-shaped optical waveguide body in which the projections are formed in the light emission surface, light can be introduced up to a position far away from the incident surface of the optical waveguide, compared to the case where the light emission surface is flat, and that the brightness around the center is improved.

Furthermore, the same front light as shown in FIG. 1 (example) is manufactured by a combination of the light source and the optical waveguide 12 according to the example fabricated in the experiment example 1. Further, for the purpose of comparison, the front light (comparative example) is manufactured by a combination of the light source and the optical waveguide 12 according to the comparative example fabricated in the experimental example 1. For these front lights, brightness inside the optical waveguide is measured by means of the same measuring method as described above, and thus the same experimental results as those of the backlight are obtained.

### Experimental Example 3

The light source and the optical waveguide 12 according to this example fabricated in the experiment example 1 are combined to form the front light as shown in FIG. 1 (example).

Further, for the purpose of comparison, the light source and the optical waveguide 12 according to a comparative example fabricated in the experiment example 1 are combined to form the front light (comparative example).

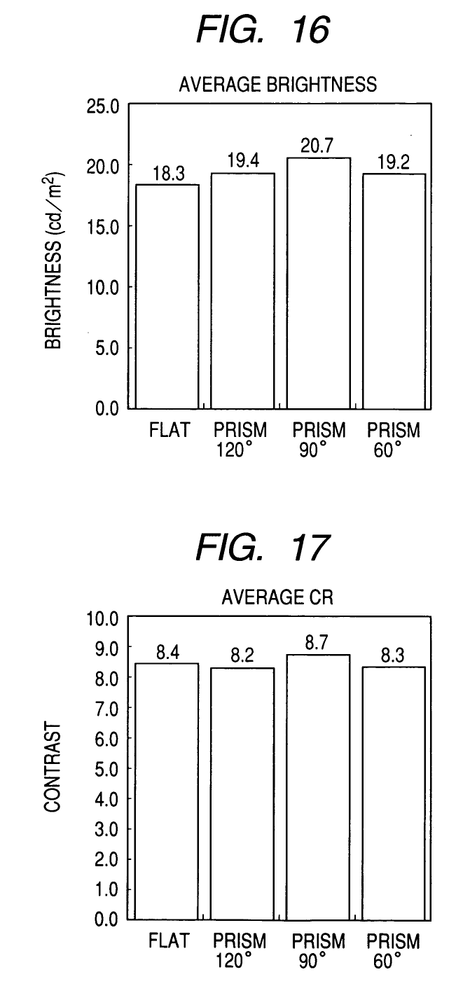

The fabricated front light is disposed on the viewing side of the reflective liquid crystal unit 20 as shown in FIG. 1 to form a liquid crystal display device. Brightness and contrast (CR) of the display surface are measured when the front light is turned on. The measured results are shown in Table 1 and FIGS. 16 and 17.

TABLE 1
Measured brightness and contrast of front light

Light
emission
surface
of rod-

| shaped | | | | | Brightness of | | | |
|---|---|---|---|---|---|---|---|---|
| optical | | Brightness of white display | | | black display | | Contrast | |
| waveguide | Apex | Average | Central | Brightness | Average | Central | Average | Center |
| body | angle | brightness | brightness | uniformity | brightness | brightness | CR | CR |
| Unit | (°) | cd/m² | cd/m² | (%) | cd/m² | cd/m² | — | — |
| Flat | 180 | 18.3 | 19.4 | 64 | 2.2 | 2.1 | 8.4 | 9.1 |
| Prism | 120 | 19.4 | 22.0 | 61 | 2.4 | 2.6 | 8.2 | 8.5 |
| 120° | | | | | | | | |
| Prism | 90 | 20.7 | 22.7 | 57 | 2.4 | 2.5 | 8.7 | 9.0 |
| 90° | | | | | | | | |
| Prism | 60 | 19.2 | 20.3 | 60 | 2.3 | 2.3 | 8.3 | 8.7 |
| 60° | | | | | | | | |

From the results shown in Table 1 and FIGS. 16 and 17, it can be seen that the liquid crystal display device (example) having the front light according an example employing the rod-shaped optical waveguide body in which a plurality of projections having an apex angle of 60° to 120° is formed in the light emission surface has the average brightness and the central brightness higher than the liquid crystal display device (comparative example) having the front light according to comparative example in terms of white display.

Furthermore, the liquid crystal display device having the front light according to the example employing the rod-shaped optical waveguide body in which the plurality of projections having the apex angle of 60° or 120° is formed in the light emission surface can have the average contrast equal to that of the liquid crystal display device of the comparative example. The liquid crystal display device having the front light according to the example that employs the rod-shaped optical waveguide body in which the plurality of projections having an apex angle of 90° is formed in the light emission surface has the average contrast higher than the liquid crystal display device of the comparative example.

### Experimental Example 4

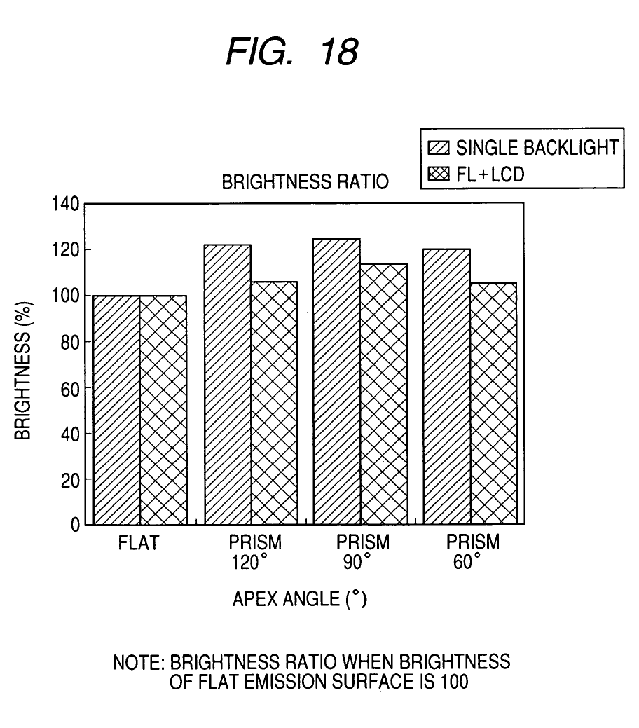

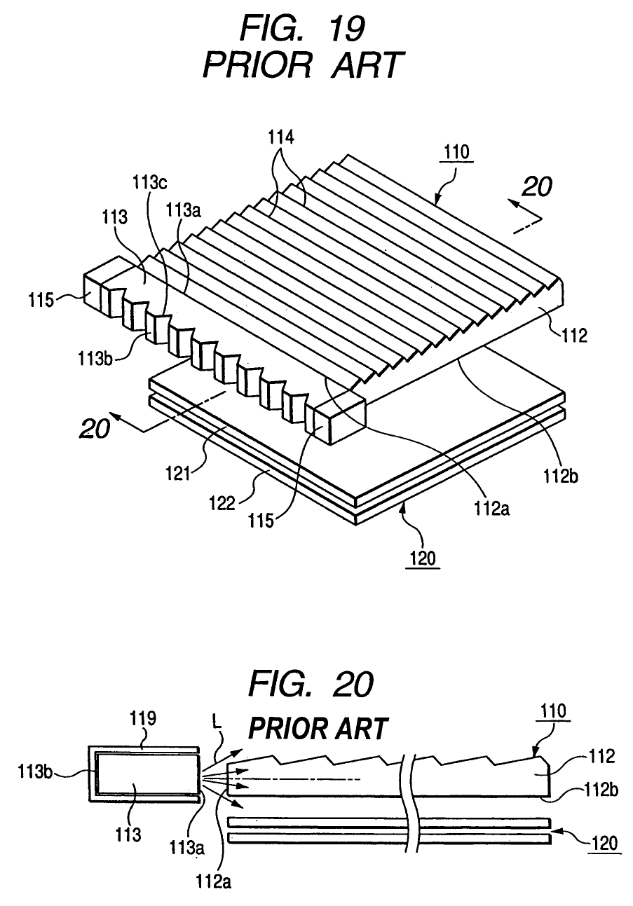

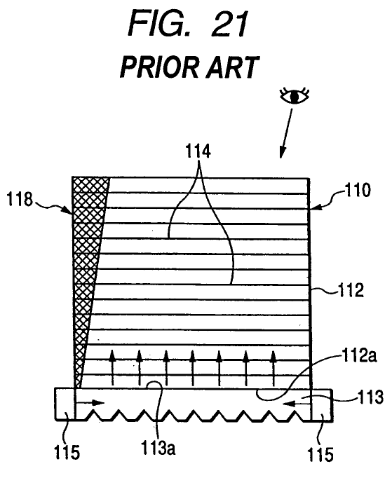

The performance of the liquid crystal display device (FL+LCD) of the example and comparative example which is fabricated in the experimental example 3 is compared to the performance of a single backlight (a single BL) of the example and comparative example which is fabricated in the experiment example 2. The comparison results are shown in Tables 2 and 3 and FIG. 18. Furthermore, the performance includes the average brightness (cd/m²) and the brightness ratio. In this case, in terms of the brightness ratio, the brightness (shown in Table 2) when the light emission surface of the rod-shaped optical waveguide body is flat is set to 100.

TABLE 2
Average brightness (cd/m²)

| Light emission surface | | |
|---|---|---|
| of rod-shaped optical | | |
| waveguide body | Single BL | FL + LCD |
| Flat | 466 | 18.3 |
| Prism 120° | 570 | 19.4 |
| Prism 90° | 580 | 20.7 |
| Prism 60° | 558 | 19.2 |

TABLE 3
Brightness ratio

| Light emission | | |
|---|---|---|
| surface of rod-shaped | | |
| optical waveguide | | |
| body | Single BL | FL + LCD |
| Flat | 100 | 100 |
| Prism 120° | 122 | 106 |
| Prism 90° | 124 | 113 |
| Prism 60° | 120 | 105 |

Values when the brightness of a flat emission surface of the rod-shaped optical waveguide body is set to 100

From the results shown in Tables 2 and 3 and FIG. 18, it can be seen that the backlight of the example has the average brightness higher than that of the backlight of the comparative example. Further, the liquid crystal display device having the front light according to the example has the average brightness higher than that of the liquid crystal display device having the front light according to the comparative example. Furthermore, in the comparison of the single backlight with the liquid crystal display device having the front light, the single backlight has a higher variation ratio of brightness when the apex angle of the projection is changed.

Furthermore, in the drawings and tables showing the results of the experimental examples 1 to 4, the term ‘flat’ indicates a case where the light emission surface of the rod-shaped optical waveguide body is flat. The term ‘prism 120’ indicates that the apex angle of the projection of the prism surface formed in the light emission surface of the rod-shaped optical waveguide body is 120°. The term ‘prism 90’ indicates that the apex angle of the projection of the prism surface formed in the light emission surface of the rod-shaped optical waveguide body is 90°. The term ‘prism 60’ indicates that the apex angle of the projection of the prism surface formed in the light emission surface of the rod-shaped optical waveguide body is 60°.

As described above, the invention can provide a surface emitting device in which light emitted from the optical waveguide body can be effectively incident on the optical waveguide, brightness inside the optical waveguide can be improved, and brightness distribution of the optical waveguide can be controlled.

Furthermore, since the surface emitting device is provided on the viewing side or rear side of a liquid crystal display panel, the visibility of display can be improved, and a liquid crystal display device having a high display quality can be provided.

1. A surface emitting device comprising:
a light source; and
an optical waveguide that receives light emitted from the light source through one side surface thereof, and which emits the light traveling therein from one surface thereof,
wherein the one side surface of the optical waveguide on which the light is incident serves as a light-incident surface, and a plurality of prism grooves is formed in another side surface of the optical waveguide in strip shapes in plan view,
the light source includes a rod-shaped optical waveguide body disposed along the light-incident surface of the optical waveguide and light-emitting elements disposed at least one end of the rod-shaped optical waveguide body in a width direction,
a side surface of the rod-shaped optical waveguide body facing the light-incident surface of the optical waveguide serves as a light emission surface through which the light from the light-emitting elements is emitted to the optical waveguide, and another side surface thereof opposite to the light emission surface serves as a reflective surface for reflecting the light traveling within the rod-shaped optical waveguide body, and
a prism surface having a plurality of projections extending in the width direction of the rod-shaped optical waveguide body is formed on the light emission surface.

2. The surface emitting device according to claim 1,
wherein the projections are long projections each having a pair of slant surfaces, and the projections have triangular shapes in longitudinal sectional view.

3. The surface emitting device according to claim 1,
wherein each of the projections has a hemispherical shape.

4. The surface emitting device according to claim 2,
wherein an apex angle of the projection formed in the light emission surface of the rod-shaped optical waveguide body is in a range of 45° to 130°.

5. The surface emitting device according to claim 1,
wherein a pitch between the projections formed in the light emission surface of the rod-shaped optical waveguide body is smaller than a third of a thickness of the rod-shaped optical waveguide body.

6. The surface emitting device according to claim 1,
wherein the prism sheet is provided on another surface of the optical waveguide, and a reflective plate is provided on the other surface of the optical waveguide.

7. The surface emitting device according to claim 1,
wherein a plurality of grooves having wedge shapes in plan view are formed parallel to each other in the reflective surface of the rod-shaped optical waveguide body along a thickness direction of the rod-shaped optical waveguide body.

8. The surface emitting device according to claim 7,
wherein the wedge-shaped groove has a largest depth at a center of the rod-shaped optical waveguide body, and a depth thereof becomes smaller with proximity to both ends of the rod-shaped optical waveguide body.

9. The surface emitting device according to claim 7,
wherein the pitch between adjacent wedge-shaped grooves is smaller as the grooves become farther from the light-emitting elements.

10. The surface emitting device according to claim 1,
wherein a thin metal film having high reflectance is formed on the reflective surface of the rod-shaped optical waveguide body.

11. A liquid crystal display device comprising:
a liquid crystal display panel; and
the surface emitting device according to claim 1 that is provided on a viewing side of the liquid crystal display panel such that one surface of an optical waveguide faces the liquid crystal display panel.

12. A liquid crystal display device comprising:
a liquid crystal display panel; and
the surface emitting device according to claim 1 that is provided on a rear side of the liquid crystal display panel such that one surface of an optical waveguide faces the liquid crystal display panel.

1. A surface emitting device comprising:
a light source; and
an optical waveguide that receives light emitted from the light source through one side surface thereof, and which emits the light traveling therein from one surface thereof,
wherein the one side surface of the optical waveguide on which the light is incident serves as a light-incident surface, and a plurality of prism grooves is formed in another side surface of the optical waveguide in strip shapes in plan view,
the light source includes a rod-shaped optical waveguide body disposed along the light-incident surface of the optical waveguide and light-emitting elements disposed at least one end of the rod-shaped optical waveguide body in a width direction,
a side surface of the rod-shaped optical waveguide body facing the light-incident surface of the optical waveguide serves as a light emission surface through which the light from the light-emitting elements is emitted to the optical waveguide, and another side surface thereof opposite to the light emission surface serves as a reflective surface for reflecting the light traveling within the rod-shaped optical waveguide body, and
a prism surface having a plurality of projections extending in the width direction of the rod-shaped optical waveguide body is formed on the light emission surface.

2. The surface emitting device according to claim 1,
wherein the projections are long projections each having a pair of slant surfaces, and the projections have triangular shapes in longitudinal sectional view.

3. The surface emitting device according to claim 1,
wherein each of the projections has a hemispherical shape.

4. The surface emitting device according to claim 2,
wherein an apex angle of the projection formed in the light emission surface of the rod-shaped optical waveguide body is in a range of 45° to 130°.

5. The surface emitting device according to claim 1,
wherein a pitch between the projections formed in the light emission surface of the rod-shaped optical waveguide body is smaller than a third of a thickness of the rod-shaped optical waveguide body.

6. The surface emitting device according to claim 1,
wherein the prism sheet is provided on another surface of the optical waveguide, and a reflective plate is provided on the other surface of the optical waveguide.

7. The surface emitting device according to claim 1,
wherein a plurality of grooves having wedge shapes in plan view are formed parallel to each other in the reflective surface of the rod-shaped optical waveguide body along a thickness direction of the rod-shaped optical waveguide body.

8. The surface emitting device according to claim 7,
wherein the wedge-shaped groove has a largest depth at the center of the rod-shaped optical waveguide body, and a depth thereof becomes smaller with proximity to both ends of the rod-shaped optical waveguide body.

9. The surface emitting device according to claim 7,
wherein the pitch between adjacent wedge-shaped grooves is smaller as the grooves become farther from the light-emitting elements.

10. The surface emitting device according to claim 1,
wherein a thin metal film having high reflectance is formed on the reflective surface of the rod-shaped optical waveguide body.

11. A liquid crystal display device comprising:
a liquid crystal display panel; and
the surface emitting device according to claim 1 that is provided on a viewing side of the liquid crystal display panel such that one surface of an optical waveguide faces the liquid crystal display panel.

12. A liquid crystal display device comprising:
a liquid crystal display panel; and
the surface emitting device according to claim 1 that is provided on a rear side of the liquid crystal display panel such that one surface of an optical waveguide faces the liquid crystal display panel.
